(19) United States
(12) Patent Application Publication
(10) Pub. No.: US 2012/0085241 A1
(43) Pub. Date: Apr. 12, 2012

(54) ELECTRICAL BEVERAGE PREPARATION MACHINE

(76) Inventors: Joerg KRUG, Steffenberg (DE); Klaus Kroesen, Xanten (DE); Christian Voigt, Xanten (DE); Sebastian Beule, Bad Fredeburg (DE)

(21) Appl. No.: 13/269,787

(22) Filed: Oct. 10, 2011

(30) Foreign Application Priority Data
Oct. 12, 2010 (DE) 102010038112.8

(51) Int. Cl. A47J 31/30

(52) U.S. Cl. 99/289 R

(57) ABSTRACT

In order to provide an electrical beverage preparation machine, in particular for preparing coffee, espresso, mixed milk drinks or the like, the machine comprising an outlet housing part that has an inlet for coffee, fresh air and hot steam as well as milk and outlets for on the one hand coffee and on the other hand milk and milk foam, wherein the coffee outlet as well as the milk frothing system can easily be cleaned, it is proposed that a connector plate is fixed in the outlet housing part, said connector plate comprising connections for the coffee inlet, the steam inlet and the air inlet, and the coffee outlet branching off therefrom, as well as a connection port or similar coupling part, which comprises the steam and air outlets, and at which a mixing chamber with a milk connection is attached in a tightly mountable or detachable manner.

### FIELD OF THE INVENTION

The invention relates to an electrical beverage preparation machine, in particular for preparing coffee, espresso, mixed milk drinks or the like, the machine comprising an outlet housing part that has an inlet for coffee, fresh air and hot steam as well as milk and outlets for on the one hand coffee and on the other hand milk and milk foam.

### BACKGROUND OF THE INVENTION

In such beverage preparation machines, cleaning of the beverage outlet is difficult. Normally, the outlet can only externally be cleaned by hand. The interior can only be flushed by an automatic flushing process of the machine. The same problem also exists for an integrated device for frothing milk. Such milk frothing systems have to be disassembled and cleaned in a costly manner, since otherwise due to remaining milk residues and the like a contamination is possible.

### OBJECT OF THE INVENTION

Based on this prior art, it is the object of the invention to provide a beverage preparation machine of the species mentioned above, wherein the coffee outlet as well as the milk frothing system can easily be cleaned.

### SUMMARY OF THE INVENTION

For achieving this object, the invention proposes that a connector plate is fixed in the outlet housing part, said connector plate comprising connections for the coffee inlet, the steam inlet and the air inlet, and the coffee outlet branching off therefrom, as well as a connection port or similar coupling part, which comprises the steam and air outlets, and at which a mixing chamber with a milk connection is attached in a tightly mountable or detachable manner.

According to this configuration, a connector plate is fixed in an outlet housing part, which even when cleaning further components remains at the beverage preparation machine, i.e. remains firmly connected with the housing thereof or is a single-piece component of the housing. This connector plate comprises connections for the coffee inlet, the steam inlet and the air inlet. From the connector plate, the coffee outlet branches off, and also a connection port or similar coupling part, which comprises the steam and air outlets, and at which a mixing chamber with a milk connection is attached in a tightly mountable or detachable manner. The outlet for milk or milk foam branches off from the mixing chamber. For the purpose of cleaning, the user can easily remove the mixing chamber, if it is to be cleaned. For this purpose, the mixing chamber is removed from the connection port or the coupling part and can then separately be cleaned and maintained.

Preferably, it is provided, for improving the cleaning possibilities, that a removable outlet is detachably connected with the outlet housing part, at which the mixing chamber with the milk connection is detachably held and which comprises a first chamber leading to a first outlet for the flow of coffee and a second chamber leading to a second outlet for the flow of milk and/or milk foam coming from the mixing chamber.

For the purpose of cleaning, the removable outlet can easily be removed from the outlet housing part. At this removable outlet, the mixing chamber with the milk connection is in turn detachably held. Further, this outlet housing part comprises a first chamber leading to a first outlet that is provided for the flow of coffee, as well as a second chamber leading to a second outlet that is provided for the flow of milk and/or milk foam coming from the mixing chamber. For the purpose of cleaning, this removable outlet can be removed from the outlet housing part, so that then all components passed by coffee, milk and/or mixed liquid are well accessible and can separately be cleaned, for instance also in a dishwasher.

It is preferred that the connector plate comprises a first nozzle connected with the connection for the steam inlet and aiming into the mixing chamber.

This nozzle required for the steam passage only is a component of the connector plate, since this nozzle will normally not get dirty during its intended use, so that an additional cleaning is not necessary.

It is preferred that the mixing chamber can be mounted with an inlet opening on the first nozzle and comprises a second nozzle, into which the mixture of steam, air and milk flows and from which the mixture is guided into the second chamber, the mixing chamber comprising between the inlet opening and the second nozzle a lateral milk supply connection.

According to this configuration, the mixing chamber can be mounted with a corresponding inlet opening on the first nozzle. A second nozzle is arranged downstream of the first nozzle, into which the mixture of steam, air and milk flows and from which the mixture is guided into the second chamber. For supplying milk, a lateral milk supply connection is provided at the mixing chamber between the inlet opening and the second nozzle.

In addition, it is provided that the connector plate is passed by an air channel that ends on the output side beside the first nozzle in the mixing chamber.

This air channel that is arranged for additionally supplying air for the purpose of the foam generation, will also regularly not be contaminated during the intended use, so that the air channel can remain undetachably connected with the connector plate. By the corresponding configuration of the orifice of the air channel and of the first nozzle, an intermixture of steam, additional air and also milk is made possible in the mixing chamber.

For an easier handling, it is further provided that the outlet can be latched with the outlet housing, and at an end part of the outlet projecting in the intended mounting position from the outlet housing, handling means for an easier unlatching are provided.

In order to allow, for different heights of the cups, an adjustment of the outlet to the respective vessel, it is further provided that the outlet housing part is held at or in another single- or multiple-piece housing part in a height-adjustable manner.

### BRIEF DESCRIPTION OF THE DRAWING

An example of execution of the invention is shown in the drawing and explained in more detail in the following. Therein:

FIG. 1 is a view of a beverage preparation machine according to the invention;

FIG. 2 is an exploded view of details of the machine being essential for the invention;

FIG. 3 is a detail seen from below;

FIG. 4 is the detail in a side view seen in a longitudinal section;

FIG. 5 is the detail seen in a section in another partial area;

FIG. 6 is the detail in a disassembled position seen in a section;

FIG. 7 is another detail in an exploded view.

### DETAILED DESCRIPTION

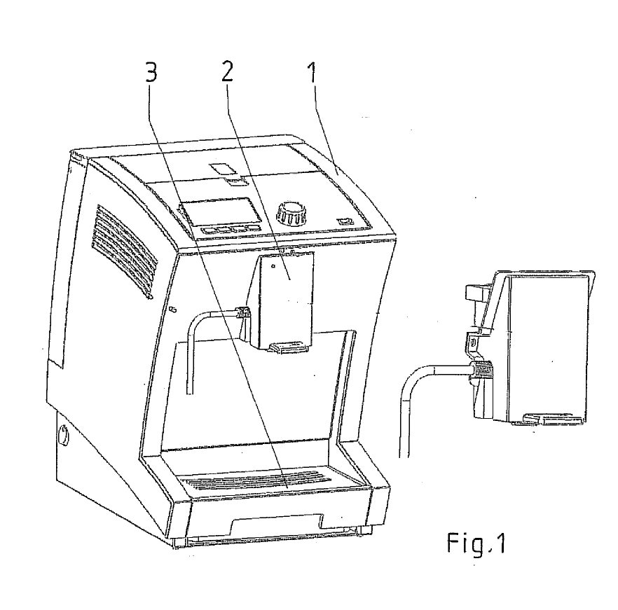

In FIG. 1 is shown an electrical beverage preparation machine in the form of an automatic coffee maker that is suitable and intended for preparing coffee, espresso, mixed milk drinks and the like. The machine 1 comprises all necessary components for preparing corresponding beverages. In the front area, the machine 1 comprises an outlet housing part 2 that is firmly connected with the machine 1, and is shown once again in FIG. 1 beside the machine 1 in a single representation. As will be explained later, the outlet housing part 2 comprises in its interior an inlet for coffee, fresh air and hot steam as well as milk, and it comprises two outlets for on the one hand coffee and on the other hand milk or milk foam at its bottom. In the lower area of the machine 1, a support stand 3 is shown, on which a cup or similar container can be placed, into which the respective beverage is poured.

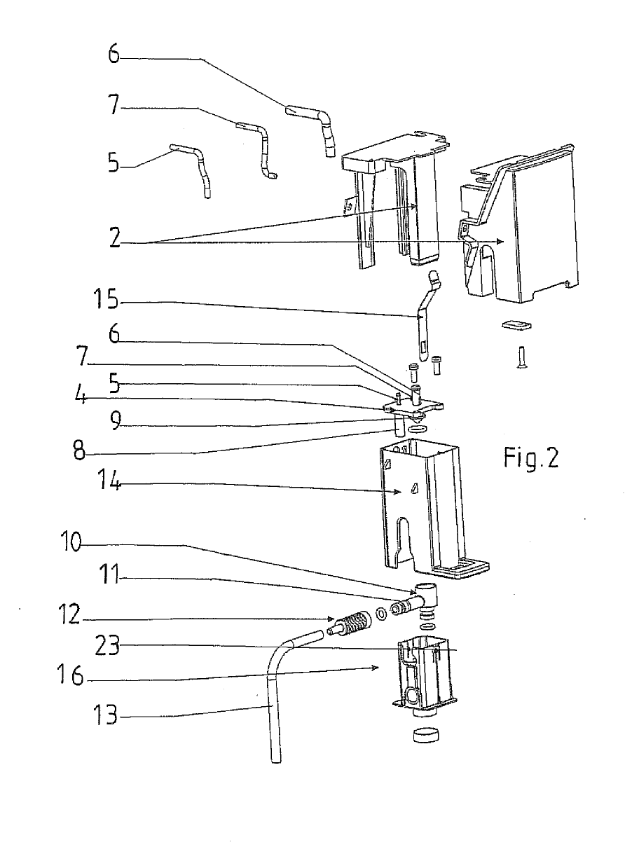

As can be seen in particular in FIG. 2, a connector plate 4 is indirectly mounted by another element in the outlet housing part 2. This connector plate comprises a connection 5 for the coffee inlet, an inlet 6 for hot steam and an inlet 7 for air supply. To theses inlets, as shown at the top of the drawing, respective hoses are connected, which are provided with the same reference numerals. The respective connections are provided at the top of the connector plate 4 in the form of ports. At the bottom of the connector plate 4 is arranged the coffee outlet 8 as well as a connection port 9 or similar coupling part, which comprises steam and air outlets and to which a mixing chamber 10 with a milk connection 11, 12, 13 is connected. The mixing chamber 10 is detachably mounted on the connection port 9 or the respective coupling part. In the outlet housing part 2, another outlet housing 14 is arranged, which is held in a height-adjustable manner relative to the stationary housing part 2, preferably by the force of a latching spring 15.

Further, a removable outlet 16 is inserted from below into the further housing part 14 and is detachably connected with the part 14. This removable outlet 16 holds the mixing chamber 10 with the milk connection 11, 12, 13. This mixing chamber with the corresponding parts is detachably held at the removable outlet 16.

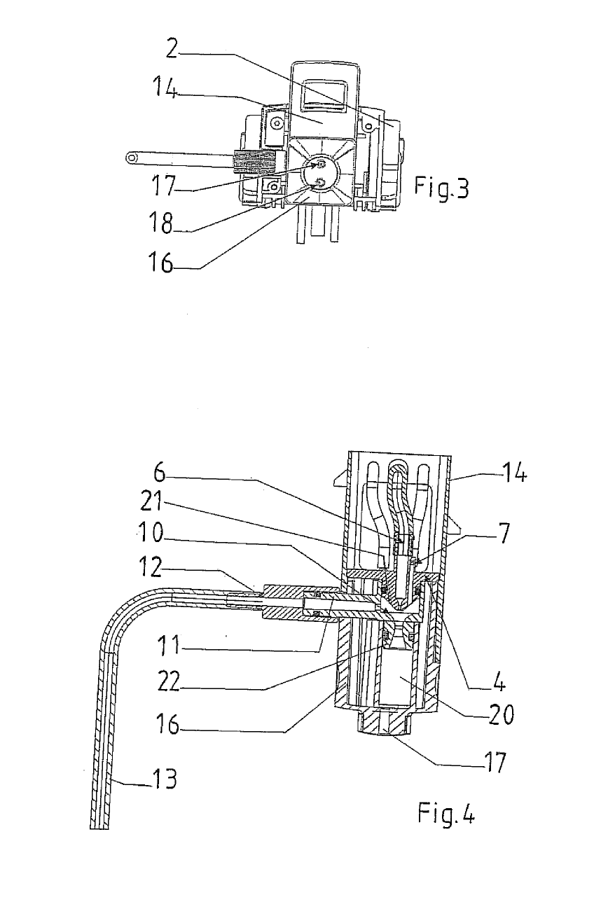

In FIG. 3 is shown from below the separate element seen in FIG. 1 on the right-hand side, the two outlet openings 17, 18 being visible.

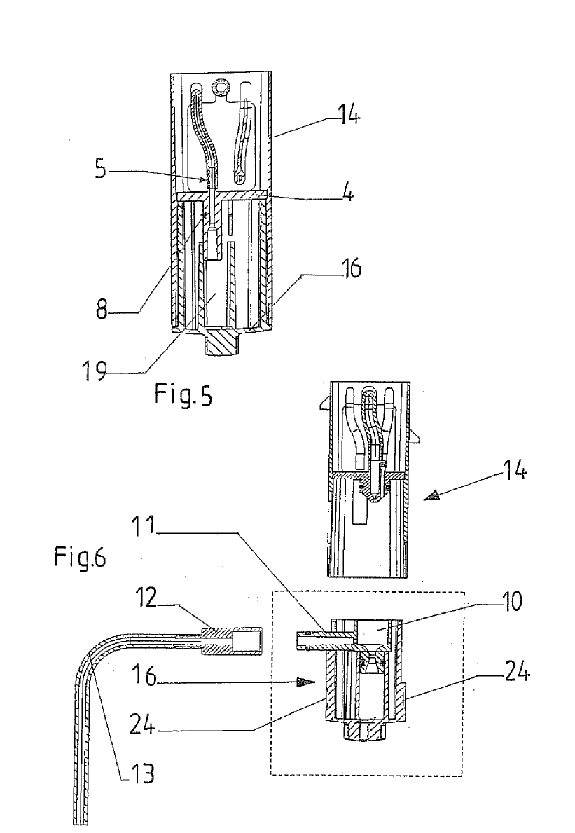

FIG. 4 shows a section of the completed element, same as in FIG. 5. In FIG. 5, the housing part 14 with the connector plate 4 is shown, and the removable outlet 14 is also shown in its intended position. It can be seen that a first chamber 19 leading to the first outlet 18 for the flow of coffee is provided, in which the coffee outlet port 8 ends.

In FIG. 4 is shown that a second chamber 20 leading to the second outlet 17 is provided, said second chamber being separate from the first chamber 19. The chamber 20 serves for the flow of milk and/or milk foam coming from the mixing chamber 10.

As can in particular be seen from FIG. 4, the connector plate 4 comprises a first nozzle 21 connected with the connection 6 for the steam inlet and ending in the mixing chamber 10. The mixing chamber 10 can tightly be mounted with an inlet opening on this first nozzle 21 (by using sealing rings) and comprises a second nozzle 22, into which the mixture of steam, air and milk flows and from which the mixture is guided into the second chamber 20. Between the inlet opening and the second nozzle 22, the mixing chamber 10 comprises a lateral milk supply connection 11.

The connector plate 4 is also passed by the air channel 7, which ends toward bottom on the output side beside the first nozzle 21 in the mixing chamber 10.

The removable outlet 16 can be latched with the housing part 14. For this purpose, the part 16 comprises latching lugs 23, and the part 14 comprises corresponding latching cutouts. An the end section of the part 16 projecting in the intended mounting position from the housing part 14, handling means 24 are provided, which make it easy for the user to grip the part 16 and unlatch and remove it from the part 14.

In FIG. 6 is shown, how the part 16 is removed from the part 14, and also how the connection 12, 13 is removed from the mixing chamber 10 or the port 11, respectively.

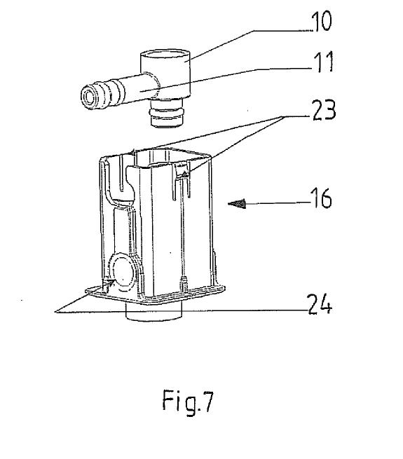

In FIG. 7 is shown, how the mixing chamber 10 is removed from the part 16 for the purpose of cleaning.

It can thus well be seen that the individual parts being particularly prone to contamination, can easily be removed from the machine 1, easily be dismantled and simply be cleaned, for instance in a dishwasher. Reassembling the parts is very easy in an analogous manner.

The invention is not limited to the embodiments, but is in many ways variable within the scope of the disclosure.

All novel individual or combined features disclosed in the description and/or drawing are deemed essential for the invention.

1. An electrical beverage preparation machine, in particular for preparing coffee, espresso, mixed milk drinks or the like, the machine comprising an outlet housing part that has an inlet for coffee, fresh air and hot steam as well as milk and outlets for on the one hand coffee and on the other hand milk and milk foam, wherein a connector plate is fixed in the outlet housing part, said connector plate comprising connections for the coffee inlet, the steam inlet and the air inlet, and the coffee outlet branching off therefrom, as well as a connection port or similar coupling part, which comprises the steam and air outlets, and at which a mixing chamber with a milk connection is attached in a tightly mountable or detachable manner.

2. The beverage preparation machine according to claim 1, wherein a removable outlet is detachably connected with the outlet housing part, at which the mixing chamber with the milk connection is detachably held and which comprises a first chamber leading to a first outlet for the flow of coffee and a second chamber leading to a second outlet for the flow of milk and/or milk foam coming from the mixing chamber.

3. The beverage preparation machine according to claim 1, wherein the connector plate comprises a first nozzle connected with the connection for the steam inlet and aiming into the mixing chamber.

4. The beverage preparation machine according to claim 3, wherein the mixing chamber can be mounted with an inlet opening on the first nozzle and comprises a second nozzle, into which the mixture of steam, air and milk flows and from which the mixture is guided into the second chamber, the mixing chamber comprising between the inlet opening and the second nozzle a lateral milk supply connection.

5. The beverage preparation machine according to claim 1, wherein the connector plate is passed by an air channel that ends on the output side beside the first nozzle in the mixing chamber.

6. The beverage preparation machine according to claim 2, wherein the outlet can be latched with the outlet housing, and at an end part of the outlet projecting in the intended mounting position from the outlet housing, handling means for an easier unlatching are provided.

7. The beverage preparation machine according to claim 2, wherein the outlet housing part is held at or in another single- or multiple-piece housing part in a height-adjustable manner.
